(19) United States
(12) Patent Application Publication
(10) Pub. No.: US 2009/0309737 A1
(43) Pub. Date: Dec. 17, 2009

(54) READER APPARATUS

(75) Inventors: Adrian Robert Bowles, Hampshire (GB); Timothy Rupert Charles Jarman, Hampshire (GB); Michael William Hopkins, Hampshire (GB)

Correspondence Address: OLIFF & BERRIDGE, PLC, P.O. BOX 320850, ALEXANDRIA, VA, 22320-4850, US

(73) Assignee: QINETIQ LIMITED, London (UK)

(21) Appl. No.: 12/375,808

(22) PCT Filed: Aug. 21, 2007
(86) PCT No.: PCT/GB07/03195

§ 371 Date: Jan. 30, 2009

(30) Foreign Application Priority Data
Aug. 26, 2006 (GB) 0616927.0

(51) Int. Cl. G08B 23/00

(52) U.S. Cl. 340/573.1

(57) ABSTRACT

Reader apparatus for receiving data from a transponder in the body of a patient, for example a femoral nail. The apparatus includes an antenna which can be varied in size and shape to fit patients, the size and shape of whose bodies vary significantly. A variable impedance unit is included to maximise power matching between the antenna and a reader unit for a given antenna configuration.

This invention relates to communications with implanted wireless transponders, and particularly but not exclusively with variable sized reader apparatus.

Medical implants are well documented and used in relation to a wide range of medical conditions. A common type of implant is a pin or nail for securing a bone after a break or fracture, and assisting in aligned bone fusion. It has been proposed that, in order to assess the rate of bone fusion, monitoring of the load levels borne by the nail or pin be performed.

Load levels can be measured by a sensor in or on the nail, and a transponder for transmitting sensed data to a reader. Because of its application inside the body however, the design limitations on the transponder are severe, and reliable communication between the transponder and the reader has proved difficult.

Techniques for transfer of data between a wireless transponder and a reader system are already used in many digital RFID (Radio Frequency Identification) systems. These RFID systems are commonly used to identify, locate or track people, assets and animals by assigning them a unique identification code stored in a microprocessor memory. One approach adopted to provide reliable read ranges is to provide a dedicated reader which is exactly tuned to a specific application or situation.

It has been appreciated however, that the precise position of the transponder in the body is likely to vary from application to application, and indeed that the shape and size of the body will vary between applications, incurring difficulties in this approach.

It is an object of the present invention therefore, to provide improved reader apparatus for receiving data from a transponder in the body of a patient

According to a first aspect of the invention there is provided reader apparatus for receiving data from a transponder in the body of a patient, the apparatus comprising an extendible antenna and a reader unit including a variable impedance unit, wherein the variable impedance unit is adjusted to maximise power matching between the antenna and the reader unit for a given antenna extension.

The variable configuration of the antenna allows the apparatus to be worn around body parts of differing sizes, and at the same time to be minimally invasive and allow free movement of the patient under study.

A change in antenna shape or extension (ie a change in the circumference or size of the antenna) however, would typically have a negative effect on the performance of the antenna which is generally part of a tuned circuit designed to be resonant at the frequency of operation. However, by varying values in the impedance unit, the system can be advantageously returned to being optimally tuned at the frequency of operation. In one embodiment power matching is employed, and in this way the transmitted radio frequency energy and the receive sensitivity remain optimised when the shape or diameter of the reader system's antenna is altered.

In an alternative embodiment, received signal quality rather than power matching between the antenna and the reader is maximised for a given antenna extension, however in certain embodiments received quality will reach a peak at maximum power matching, and therefore both variables can be used in combination, either selectively or simultaneously.

Conveniently, the variable impedance unit is coupled to the antenna such that adjustment of the antenna to a selected extension automatically adjusts the variable impedance unit to a corresponding impedance value. Arranging for adjustment to be automatic in this way improves reliability and convenience for the user.

The impedance unit is advantageously adjusted in dependence upon the antenna extension. Such a system can be manufactured simply and will typically operate between fixed antenna size increments.

In more sophisticated embodiments however, the receiver apparatus is adapted to determine a measure of received signal quality or power matching, and the variable impedance unit is automatically adjusted in dependence upon said measure. This arrangement is suitable where a continuously variable antenna is desired.

The invention extends to apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying drawings, in which:

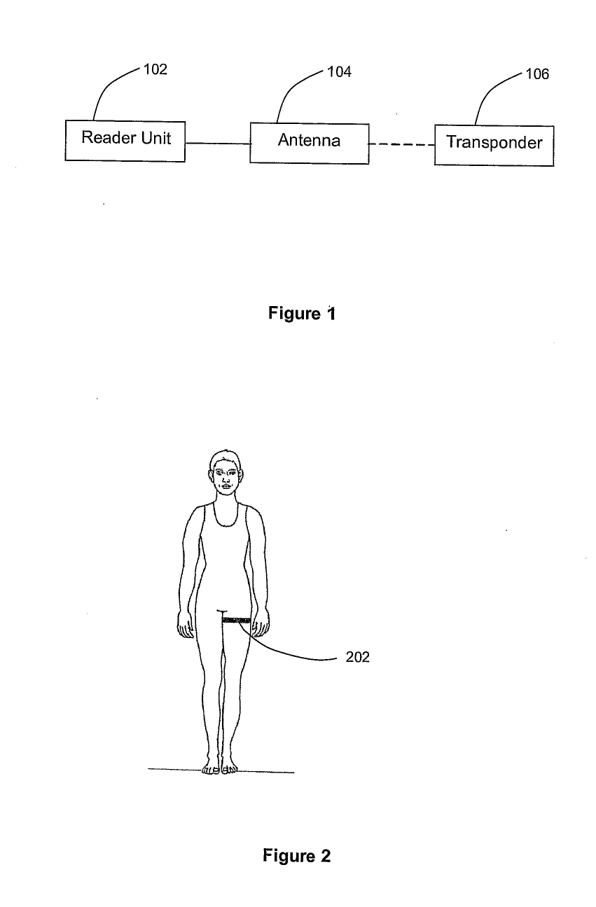

FIG. 1 is a basic schematic of a reader system

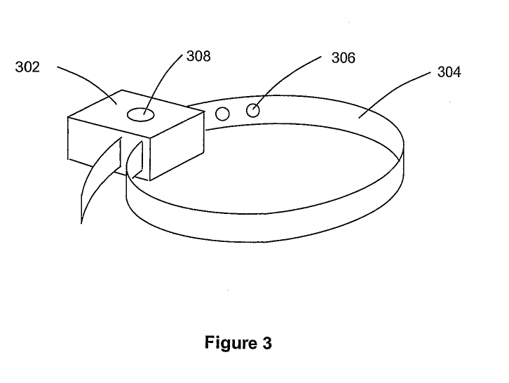

FIG. 2 illustrates a reader placed on the upper leg

FIG. 3 shows one embodiment of the invention

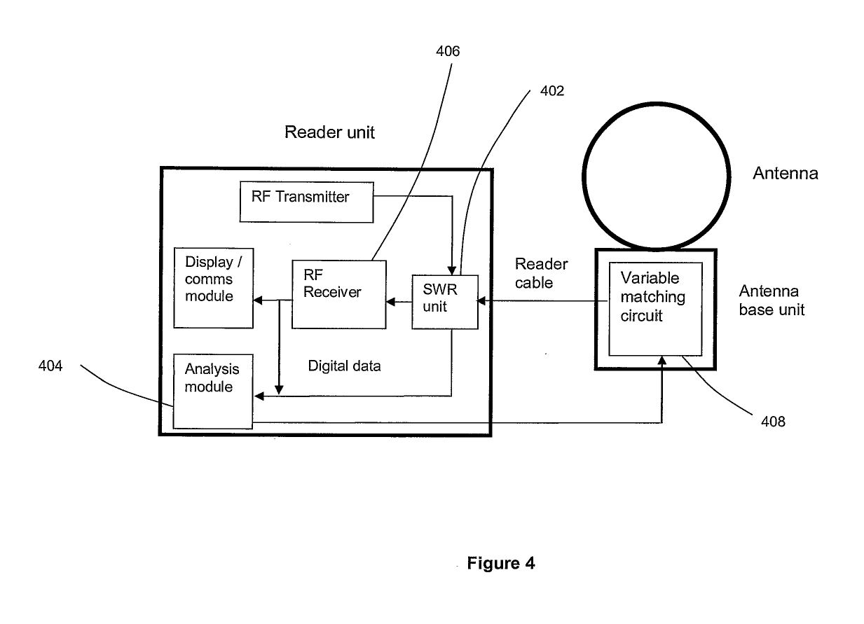

FIG. 4 illustrates components of a further embodiment of the invention

Referring to FIG. 1, a reader system 102 is connected to an antenna 104, and communicates remotely with a transponder 106 which includes a small coil antenna (not shown). Power and data are inductively coupled between the reader system and the remotely positioned ‘transponder’. This inductively coupled method of power and data transfer behaves in a similar way to the coupling between the two windings of a loosely coupled transformer, where the reader system can be thought of as the primary and the transponder circuit as the secondary winding. This principal of operation can be termed a duplex system as data is transferred from the transponder to the reader at the same time as power is supplied from the reader to the transponder.

The reader unit generates a time varying electromagnetic radio frequency wave. A predominantly magnetic field is generated, which in turn induces a voltage across the transponder's antenna. The transponders' presence in the magnetic field of the reader causes a slight dip in the voltage across the reader coil antenna as would occur in two loosely coupled transformer windings when loading of the secondary will cause a resulting effect in the primary.

Data is transferred from the remote transponder to the reader by altering the electrical impedance or resonant frequency of the transponder. This causes the load presented to the reader, and hence the voltage measured across the reader coil antenna, to vary. The impedance value or tuned frequency is switched by a simple FET (Field Effect Transistor) modulator switch, producing periodic amplitude modulated (AM) power fluctuations which are detected by measuring the voltage on the reader antenna.

The sensor state is measured by the transponder electronics using a microcontroller and/or analogue circuit. The transponder electronics is powered using the voltage induced across the transponder's antenna which is rectified to a D.C. voltage. The transponder electronics also convert the sensor data into a suitable form for transmission to the reader.

In this system, the transponder has no battery and is termed a passive transponder. The transfer of energy from the reader to the transponder is also continuous. It will be understood however that the present invention is equally applicable to transponders that are active (battery powered) or are sequential (data transfer from the transponder to the reader occurs in the pauses between power supply from the reader to the transponder).

FIG. 2 illustrates an example of a system communicating with a transponder implanted in the upper leg. The reader antenna 202 is worn around the leg of a patient, and wraps around the thigh at the joint below the buttock. The reader antenna will need to change its circumference by approximately 200% to tightly fit adults at the extremities of the 5^{th} and 95^{th} percentile population.

Such a change in circumference of the antenna will change its value of electrical impedance meaning that the system is no longer tuned for operation at the desired frequency of operation. This will significantly decrease the performance of the reader system most notably in the range that it can still perform communication with the transponder.

However, by varying the reactive values in the electrical matching circuit, the system can at once return to being optimally tuned at the frequency of operation.

Referring to FIG. 3, an adjustable reader antenna comprises an antenna base unit 302, and an antenna loop 304. The loop includes a number of indentations 306, defining discrete loop circumferences. The dimensions of the loop are such that it can fit around a body part (eg the upper thigh) for a wide range of body sizes, and may also fit around a number of different parts of the body (eg the upper arm or lower leg). The loop is slidable to any numbered preset position, and a latch in the base unit is operated by button 308 to lock the antenna at a selected size, and at the same time to secure electrical integrity of the loop.

The base unit reads the selected position from identification markings on the slidable portion of the loop at each position and, based on the information of the selected position, the base unit automatically switches between a bank of capacitors in a variable matching circuit. The capacitor values are predetermined to provide maximised electrical power matching between the reader cable and the antenna loop and optimal receive sensitivity, for the selected antenna dimension. in a less sophisticated embodiment, the switching of capacitors may be by a user operated switch or dial on the base unit, which has a plurality of numbered positions corresponding to selectable antenna positions.

In an alternative embodiment, illustrated in FIG. 4, the point of maximum transmitted radio frequency energy and optimal receive sensitivity can be automatically deduced at the reader unit for any antenna diameter (or length or shape) of a continuously variable antenna.

The transmitted radio frequency energy is monitoring by the Standing Wave Ratio (SWR) unit 402 and it passes the value of transmitted energy to the analysis module 404. The peak amplitude of the received digital data or the quality of received digital data is measured by the analysis module post amplification and filtering by the RF receiver 406. A measurement of these properties can be performed periodically or whenever the diameter of the reader system's antenna is altered.

These measurements made at the reader unit by the SWR or analysis module determine whether the matching circuit's current setting in the antenna base unit is optimal. If it is deemed non-optimal, control signals are sent by the analysis module to the variable matching circuit 408 in the base unit. The matching circuit parameters are adjusted in one of two ways. The correct value of the matching circuit can be deduced using either a look-up table or in a sequential manner, altering the matching circuit values until an optimum is reached.

Variation in the matching circuitry is performed by switching a multiplicity of reactive components such as capacitors or inductors in and out of the matching circuitry using relays, transistors or PIN diodes. Alternatively, a variable reactance component such as a variable capacitor or variable inductor can be altered using a motorised drive.

It will be understood that the present invention has been described above purely by way of example, and modification of detail can be made within the scope of the invention. Each feature disclosed in the description, and (where appropriate) the claims and drawings may be provided independently or in any appropriate combination.

1. Reader apparatus for receiving data from a transponder in the body of a patient, the apparatus comprising:
an extendible antenna and
a reader unit including a variable impedance unit
wherein the variable impedance unit is adjusted to maximise power matching between the antenna and the reader unit for a given antenna extension.

2. Apparatus according to claim 1, wherein the variable impedance unit is coupled to the antenna such that adjustment of the antenna to a selected extension automatically adjusts the variable impedance unit to a corresponding impedance value.

3. Apparatus according to claim 2, wherein said impedance unit is adjusted in dependence upon the antenna extension.

4. Apparatus according to any preceding claim 1, wherein the antenna is extendible in discrete increments.

5. Apparatus according to claim 1, wherein the variable impedance unit is adjustable in discrete increments.

6. Apparatus according to claim 1, adapted to determine a measure of power matching, and whereby the variable impedance unit is automatically adjusted in dependence upon said measure.

7. Apparatus according to claim 1, adapted to determine a measure of quality of the received signal, and whereby the variable impedance unit is automatically adjusted in dependence upon said measure.

8. Apparatus according to claim 6, wherein the Standing Wave Ratio (SWR) is monitored at the reader.

9. Apparatus according to claim 6, wherein the received signal amplitude is monitored at the reader.

10. Apparatus according to claim 6, wherein said measure is determined periodically.

11. Apparatus according to claim 6, wherein said measure is determined after each adjustment in length of the antenna.

12. Apparatus according to claim 1, wherein the antenna is adapted to be worn about the body.
